(19) United States
(12) Patent Application Publication
(10) Pub. No.: US 2004/0042337 A1
(43) Pub. Date: Mar. 4, 2004

(54) Food processors

(76) Inventors: Chung Kwong Yiu, Hong Kong (HK); Nam Fong Lau, Hong Kong (HK)

Correspondence Address: PILLSBURY WINTHROP, LLP, P.O. BOX 10500, MCLEAN, VA, 22102, US

(21) Appl. No.: 10/424,122

(22) Filed: Apr. 28, 2003

(30) Foreign Application Priority Data
Sep. 4, 2002 (EP) 02256141.9

(51) Int. Cl. B01F 7/16

(52) U.S. Cl. 366/199; 366/205; 366/206

(57) ABSTRACT

A food processor (1) comprises a processing container (3) containing a processing blade (20), a lid (4) and a drive unit (2). Both the lid (4) and the drive unit (2) are connectable to the processing container (3). The drive unit (2) is operable to drive the processing blade (20) only when the lid (4) is fitted and when the processing container (3) is locked onto the drive unit (2).

### FIELD OF THE INVENTION

The present invention relates to food processors, in particular, although not exclusively, to blenders.

### BACKGROUND OF THE INVENTION

It is well known that blenders comprise a jug for containing a processing blade, which jug attaches to a base motor unit for driving the processing blade. Generally, such blenders have a safety device such that the motor is only activated when the jug is locked onto the motor base.

it is common to find a blender jug having an integral handle formed from the same material as the jug, which material is usually glass.

Prior art blenders do not account for hazards associated with the rotating blade whilst the lid of the blender is removed. When the blade rotates, without the lid, material contained within the jug may be displaced from the jug.

A more serious hazard, associated with an open blender jug during operation of the blade, may be injury to the operator; for example, if the operator tries to push material into the jug, it is likely that injury to the operator's fingers and/or hands will be sustained.

Therefore, it is an object of preferred embodiments of the present invention to provide an improved blender.

### SUMMARY OF THE INVENTION

Accordingly, the present invention provides a food processor comprising a processing container having an opening for placing food into the container and a processing mechanism operable to process food in the container; a lid engageable with the processing container to close the opening thereof; and a drive unit engageable with the processing container. The drive unit is operable to drive the processing mechanism only when both the lid and the drive unit are operably engaged with the processing container.

Optionally, the processing container comprises a jug. The jug may comprise a base unit, which base unit may be integral with or separate from the jug.

Optionally, the processing container comprises a handle. The handle suitably has an elongate conformation. Advantageously, the handle extends along the full height of the processing container.

Optionally, the handle comprises a first member and a second member. The first and second members may be complementary elongate portions joining together to form the handle.

The handle, and preferably the first member of the handle may comprise attachment means to allow the handle to be attached to the processing container. Any suitable fixing means may be used with the attachment means to attach the handle to the container. For example, the fixing means may comprise a mechanical fastener, such as a screw, rivet or similar. Alternatively, or in addition, the fixing means may comprise any suitable adhesive, cement or the like.

The first member may provide an inner surface of the handle. Preferably, at least part of a surface of the first member comprises an undulating profile providing a gripping section for a user.

Also, the second member may provide an outer surface of the handle.

The handle suitably comprises a passage extending therein, along at least a portion of the longitudinal extent thereof. The handle may be hollow along at least a portion thereof. Preferably, the handle is hollow along substantially the full, and more preferably the full, extent thereof.

Preferably, the food processor further comprises an actuator for signalling that the lid is operably engaged with the processing container.

The actuator may be movable between an open position, wherein the lid is not operably engaged with the processing container, and a closed position, wherein the lid is operably engaged with the processing container. Suitably, the actuator is biased into an open position.

Optionally, the actuator is an elongate member having a first and second end. Suitably, a pressure applied at the first end moves the actuator to the closed position.

Alternatively, or in addition, the actuator may comprise an electrical contact. Suitably, the electrical contact is in an open state when the lid is not operably engaged with the processing container and in a closed state when the lid is operably engaged with the processing container.

The actuator may be conductive. The actuator may comprise a conductive portion.

The actuator may be associated with the handle of the processing container. Suitably, the actuator extends along the full extent of the handle and at least part of the actuator may be contained within the handle. Suitably, the handle comprises a passage extending along the full extent thereof and the actuator extends along the full extent of the passage. Preferably, the handle is hollow along the full extent thereof and the actuator is contained within the handle and extends along the full extent thereof. The actuator may extend beyond one or both ends of the handle.

The lid may be operably engaged with the processing container when the lid is locked in a closed position on the processing container.

Optionally, the food processor comprises an alignment mechanism for positioning the processing container relative to the drive unit. Any suitable alignment mechanism may be used.

The alignment mechanism may comprise an opening in the drive unit for receiving an element of the processing container, or vice versa. Suitably, the alignment mechanism comprises an opening in the drive unit for receiving the actuator.

The drive unit may also comprise a controller, which controller comprises a switch assembly.

The switch assembly suitably comprises first and second contacts, which are biased into an open position. Suitably, at least one of, and preferably both of, the first and second contacts are spring mounted. One or both of the first and second contacts may be mounted on a contact holder.

Movement of the actuator may cause movement of the first and/or second contacts. Suitably, the actuator contacts the first and/or second contact in order to move the first and second contacts from the open position to the closed position. Preferably, the actuator contacts the contact holder of the first and/or second contact in order to move the first and second contacts from the open position to the closed position.

Optionally, the switch assembly cooperates with the actuator and the alignment mechanism such that when the processing container is correctly positioned on the drive unit and the lid is operably engaged with the processing container, the switch assembly allows activation of the control means.

Suitably, movement of the actuator indicates to the switch assembly that the lid is operably engaged with the processing container.

The lid may be configured to cooperate with the actuator so as to effect movement of the actuator. Suitably, the lid comprises a protrusion, which interacts with the actuator when the lid is operably engaged with the processing container to effect movement of the actuator.

The processing mechanism is part of the base unit. Suitably, the processing mechanism is detachable from the base unit; therefore facilitating easier cleaning.

The lid may comprise an opening and a removable plug. The opening advantageously provides a filling port for safe addition of material to the processing container whilst the food processor is in use.

Other objects, features and advantages of the present invention will become apparent from the following detailed description, the accompanying drawings, and the appended claims.

### BRIEF DESCRIPTION OF THE DRAWINGS

An embodiment of the invention will now be described, by way of example only, with reference to the accompanying schematic drawings, in which:

FIG. 1 is a partially exploded view of a blender type food processor;

FIG. 2 shows the blender of FIG. 1 when assembled for use;

FIG. 3 shows an exploded view of a processing container for the blender of FIGS. 1 and 2;

FIG. 4 shows an exploded view of the drive unit of the blender of FIGS. 1 and 2;

FIG. 5a shows the switch assembly of FIG. 4 as assembled and viewed from the direction indicated by arrow A;

FIG. 5b shows the switch assembly of FIG. 4 as assembled and viewed from the direction indicated by arrow B;

FIG. 6a shows the switch assembly of FIGS. 5a and 5b in an open position;

FIG. 6b shows the switch assembly of FIG. 6b in a closed position; and

FIG. 7 shows a sectional view of the blender as previously shown in FIG. 2.

Throughout the Figures like reference numerals are used to refer to like features.

### DETAILED DESCRIPTION OF THE ILLUSTRATED EMBODIMENT

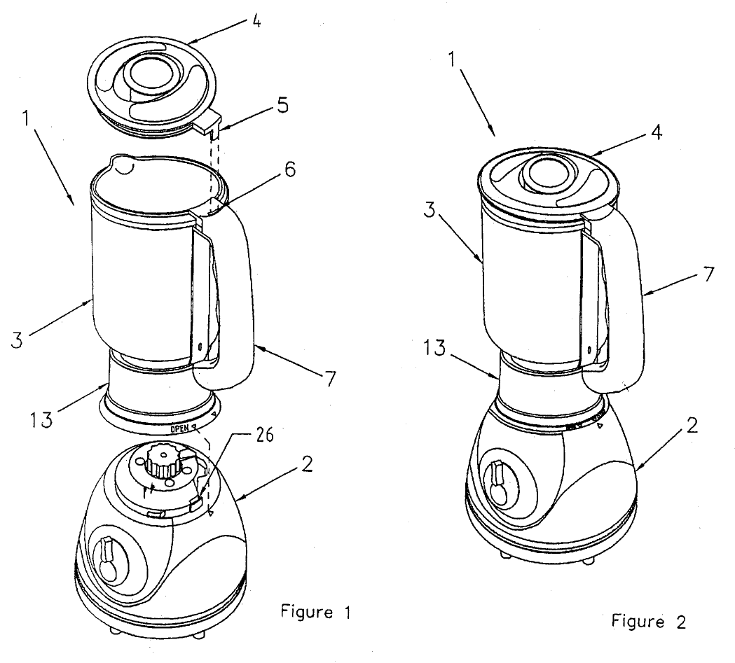

The blender 1, of FIGS. 1 to 6, comprises three main parts, a drive unit 2, a processing container 3 having an opening for enabling food to be placed in the container 3, and a lid 4 for closing the opening.

The processing container 3 comprises a handle assembly 7 and a jug 9. The jug 9 has a base unit 13. A processing mechanism having at least one processing blade 20 is located in the base unit 13. The processing mechanism may have any number of blades 20 and may have any suitable construction for processing food. In the context of the invention, the term food is intended to be read broadly and processing food may include processing solid foods, such as grinding vegetables, or liquid foods, such as blending milkshakes. Blades need not be used, and grinding elements or the like may be substituted therefor.

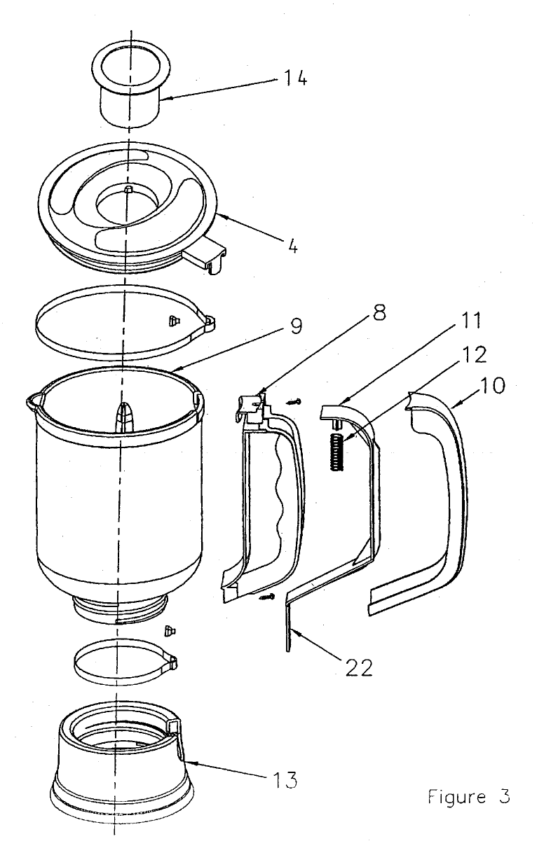

The handle assembly 7 (shown exploded in FIG. 3) extends the full height of the jug 9, and includes two elongate members 8, 10. An inner member 8 of the handle assembly has an undulating profile to provide a comfortable grip for the operator. The inner member 8 also provides attachment means for connecting the handle assembly 7 to the jug 9. In the embodiment shown, the inner member 8 is connected to the jug 9 by screws, but any other mechanical fastener, adhesive or a combination thereof may be used.

An outer member 10 of the handle assembly 7 provides the outer casing for the handle assembly 7. The inner 8 and outer 10 members form two halves of the handle assembly 7, which when joined together provide a hollow handle 7.

An actuator 11 has a shape that corresponds substantially with the profile of the handle assembly 7. The actuator 11 extends through the hollow handle assembly 7. A spring 12 is seated between the upper end of the actuator 11 and the interior upper surface of the inner member 8. The spring 12 biases the upper end of the actuator 11 towards the outer member 10.

A slot 6 is provided at the top of the handle assembly 7, between the inner 8 and outer 10 members, providing access to the upper end of the actuator 11.

The lid 4 has a protruding lug 5 that fits into slot 6 when the lid 4 is fitted to the jug 9. The lid 4 also has an opening and a removable plug 14 to allow material to be added to the jug 9 whilst the blender 1 operates.

It should be understood that the container 3 can have any construction or configuration and the invention is not limited to the one illustrated.

A drive means 24, such as an electric motor, is housed in the drive unit 2 provides driving power to the processing blade 20 via a cog 21. The drive unit 2 comprises a controller, illustrated by way of example as a safety switch assembly 15 that will prevent activation of the drive means 24 unless electrical contact is made between contacts 16, 17 of the switch assembly 15.

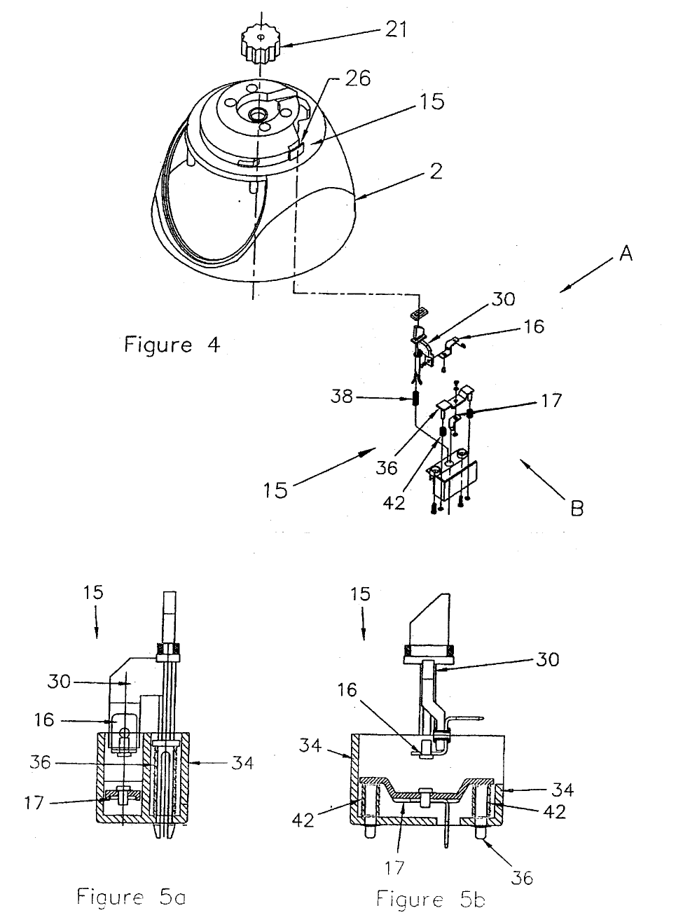

The switch assembly is shown in exploded view in FIG. 4 and assembled in FIGS. 51, 5b, 6a and 6b.

The switch assembly 15 comprises a first contact holder 30, which has a dog-legged configuration. The switch assembly further comprises a second contact holder 36. The first contact 16 is mounted in the contact support 32 and the second contact 17 is mounted in the second contact holder 36. In this embodiment, the first contact 16 and the second contact 17 are connected to the respective contact holder 30, 36 by means of a silver faced bimetallic rivet.

The first and second contacts 16, 17 are mounted within a housing 34. The first contact holder 30 is spring mounted within the housing 34 by means of a spring 38. The second contact holder 36 is spring mounted within the housing 34 by means of springs 42.

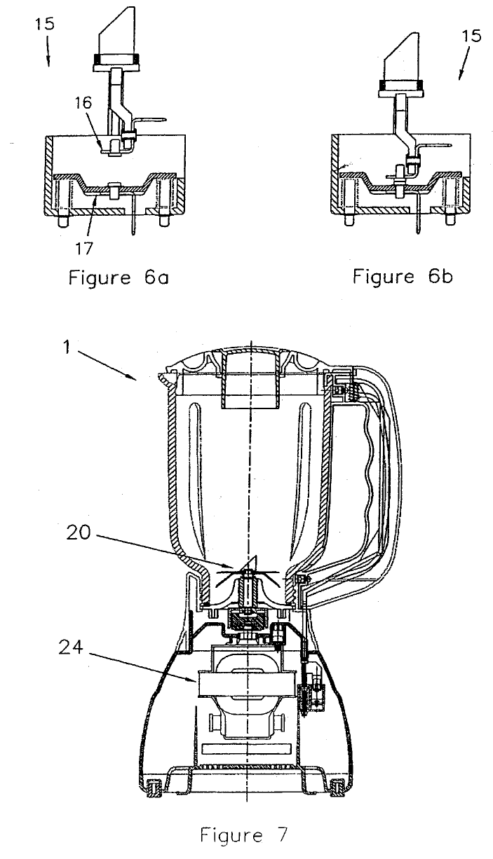

As can be seen from FIGS. 6a and 6b, when the switch assembly 15 is open, the contacts 16, and 17 are maintained separated from one another by means of the spring 38. When a downwards force is applied to the first contact holder 30 by means of the actuator 11, the spring force 38 is overcome and the contacts 16, 17 are brought together to move the switch assembly to the closed position.

In the closed position, the electric circuit to the drive unit 2 can be completed to allow activation of the drive means 24.

The drive unit 2 further comprises an alignment mechanism, illustrated by way of example as an alignment opening 26. The alignment opening 26 is located to be aligned with the lower end 22 of the actuator 11 when the jug 9 is correctly positioned on the drive unit 2. Any suitable mechanism for facilitating alignment may be used.

It should be understood that the drive unit 2 may have any construction or configuration and the present invention is not limited to the one illustrated.

Safe operation of the blender 1 depends on both, the lid 4 being fitted to the jug 9, and the processing container 3 being correctly aligned on the drive unit 2.

The processing container 3 attaches to the drive unit 2, via the base unit 13, by twisting into a locking position, in which it is correctly aligned. The locked and unlocked positions are indicated visually by alignment of arrows on the casing of the drive unit 2 and the casing of the base unit 13 (see FIG. 1).

When the base unit 13 is locked onto the drive unit 2, the lower end 22 of the actuator 11 is axially aligned with the safety switch assembly 15. When the lid 4 is fitted on the jug 9 the protruding lug 5 enters the slot 6 (see FIG. 1). The lug 5 connects with the upper end of the actuator 11 and pushes it downward against the restraint of spring 12. As the actuator 11 moves downwards its lower end 22 passes through the alignment opening 26 and makes contact with the first contact holder 30 of the safety switch assembly 15 which effects contact of the first and second contacts 16,17 allowing current flow through the safety switch assembly 15 allowing safe operation of the blender 1 via the control unit.

Conversely, removal of the lid 4 causes expansion of the spring 12, thereby raising the actuator 11 to break the contact between the lower end 22 of the actuator 11 and the first contact holder 30. The force of spring 38, will then cause the first and second contact 16, 17 to separate, thus preventing operation of the drive means 24.

Only when both the first 16 and second 17 contacts are closed can current flow through the switch assembly 15 to activate the processing blade 20.

The foregoing description has been provided solely to illustrate the structural and functional principles of the present invention and is not intended to be limiting. To the contrary, the present invention is intended to encompass all substitutions, modifications, alterations and equivalents within the spirit and scope of the appended claims.

1. A food processor comprising:
a processing container having an opening for placing food into the container and a processing mechanism operable to process food in the container,
a lid engageable with the processing container to close the opening thereof, and
a drive unit engageable with the processing container, the drive unit being operable to drive the processing mechanism only when both the lid and the drive unit are engaged with the processing container.

2. A food processor according to claim 1, wherein the processing container comprises a jug, a handle and an actuator.

3. A food processor according to claim 2, wherein the handle is hollow.

4. A food processor according to claim 3, wherein the actuator is an elongate member having a first end and a second end.

5. A food processor according to claim 4, wherein the actuator extends within the handle.

6. A food processor according to claim 5, wherein the drive unit comprises a controller, the controller comprising a switch.

7. A food processor according to claim 6, wherein movement of the actuator indicates to the switch that the lid is operably engaged with the processing container.

8. A food processor according to 7, wherein the lid is configured to cooperate with the actuator so as to effect movement of the actuator when the lid is operably engaged with the processing container.

9. A food processor according to claim 8, wherein the actuator is biased into an open position when the lid is not operably engaged with the processing container.

10. A food processor according to claim 9, wherein movement of the actuator effects movement of a contact in the switch to move the switch from an open condition to a closed condition.

11. A food processor according to claim 2, wherein the jug comprises a base unit.

12. A food processor according to claim 11, wherein the processing mechanism is part of the base unit.

13. A food processor according to claim 12, wherein the processing mechanism is detachable from the base unit.

14. A food processor according to claim 13, wherein the drive unit comprises an alignment mechanism located to be aligned with a lower end of the actuator when the processing container is correctly positioned on the drive unit.

15. A food processor according to claim 2, wherein the actuator is an elongate member having a first end and a second end.

16. A food processor according to claim 2, wherein the actuator extends within the handle.

17. A food processor according to claim 3, wherein the actuator extends within the handle.

18. A food processor according to claim 1, wherein the drive unit comprises a controller, the controller comprising a switch.

19. A food processor according to claim 2, wherein the drive unit comprises a controller, the controller comprising a switch.

20. A food processor according to claim 3, wherein the drive unit comprises a controller, the controller comprising a switch.

21. A food processor according to claim 4, wherein the drive unit comprises a controller, the controller comprising a switch.

22. A food processor according to claim 19, wherein movement of the actuator indicates to the switch that the lid is operably engaged with the processing container.

23. A food processor according to claim 20, wherein movement of the actuator indicates to the switch that the lid is operably engaged with the processing container.

24. A food processor according to claim 21, wherein movement of the actuator indicates to the switch that the lid is operably engaged with the processing container.

25. A food processor according to 2, wherein the lid is configured to cooperate with the actuator so as to effect movement of the actuator when the lid is operably engaged with the processing container.

26. A food processor according to 3, wherein the lid is configured to cooperate with the actuator so as to effect movement of the actuator when the lid is operably engaged with the processing container.

27. A food processor according to 4, wherein the lid is configured to cooperate with the actuator so as to effect movement of the actuator when the lid is operably engaged with the processing container.

28. A food processor according to 5, wherein the lid is configured to cooperate with the actuator so as to effect movement of the actuator when the lid is operably engaged with the processing container.

29. A food processor according to 6, wherein the lid is configured to cooperate with the actuator so as to effect movement of the actuator when the lid is operably engaged with the processing container.

30. A food processor according to claim 2, wherein the actuator is biased into an open position when the lid is not operably engaged with the processing container.

31. A food processor according to claim 3, wherein the actuator is biased into an open position when the lid is not operably engaged with the processing container.

32. A food processor according to claim 4, wherein the actuator is biased into an open position when the lid is not operably engaged with the processing container.

33. A food processor according to claim 5, wherein the actuator is biased into an open position when the lid is not operably engaged with the processing container.

34. A food processor according to claim 6, wherein the actuator is biased into an open position when the lid is not operably engaged with the processing container.

35. A food processor according to claim 7, wherein the actuator is biased into an open position when the lid is not operably engaged with the processing container.

36. A food processor according to claim 7, wherein movement of the actuator effects movement of a contact in the switch to move the switch from an open condition to a closed condition.

37. A food processor according to claim 8, wherein the jug comprises a base unit.

38. A food processor according to claim 3, wherein the drive unit comprises an alignment mechanism located to be aligned with a lower end of the actuator when the processing container is correctly positioned on the drive unit.

39. A food processor according to claim 4, wherein the drive unit comprises an alignment mechanism located to be aligned with a lower end of the actuator when the processing container is correctly positioned on the drive unit.

40. A food processor according to claim 5, wherein the drive unit comprises an alignment mechanism located to be aligned with a lower end of the actuator when the processing container is correctly positioned on the drive unit.

41. A food processor according to claim 6, wherein the drive unit comprises an alignment mechanism located to be aligned with a lower end of the actuator when the processing container is correctly positioned on the drive unit.

42. A food processor according to claim 7, wherein the drive unit comprises an alignment mechanism located to be aligned with a lower end of the actuator when the processing container is correctly positioned on the drive unit.

43. A food processor according to claim 8, wherein the drive unit comprises an alignment mechanism located to be aligned with a lower end of the actuator when the processing container is correctly positioned on the drive unit.

44. A food processor according to claim 9, wherein the drive unit comprises an alignment mechanism located to be aligned with a lower end of the actuator when the processing container is correctly positioned on the drive unit.

45. A food processor according to claim 10, wherein the drive unit comprises an alignment mechanism located to be aligned with a lower end of the actuator when the processing container is correctly positioned on the drive unit.
